(19) United States
(12) Patent Application Publication
(10) Pub. No.: US 2022/0328409 A1
(43) Pub. Date: Oct. 13, 2022

(54) TARGETED POWER GRID STRUCTURE AND METHOD

(71) Applicant: Taiwan Semiconductor Manufacturing Company, Ltd., Hsinchu (TW)

(72) Inventors: Ho-Che Yu, Zhubei (TW); Fong-yuan Chang, Hsinchu (TW); Po-Hsiang Huang, Taiwan (TW); Ching-Yi Lin, Zhubei (TW); Chen-Yi Chang, Kaohsiung (TW)

(21) Appl. No.: 17/538,080

(22) Filed: Nov. 30, 2021

Related U.S. Application Data
(60) Provisional application No. 63/172,469, filed on Apr. 8, 2021.

(51) Int. Cl. H01L 23/528

(52) U.S. Cl. CPC H01L 23/5286; H01L 23/5226

(57) ABSTRACT

In some embodiments, a low-resistance path between an active cell and a power supply layer in an integrated circuit device includes at least one layer of a plurality of conductive lines commonly connected to at least one conductive line through a plurality of respective conductive pillars, the at least one conductive line being in the power supply layer or intervening the active cell and the power supply layer. In some embodiments, the integrated circuit device includes a conductive layer that includes the plurality of conductive lines and additional conductive portions, where the plurality of conductive lines are isolated from the additional conductive portions.

### CROSS-REFERENCE TO RELATED APPLICATIONS

The present application claims the benefit of U.S. Provisional Patent Application No. 63/172,469, titled “TARGETED POWER GRID STRUCTURE AND METHOD” and filed Apr. 8, 2021, the disclosure of which is hereby incorporated by reference in its entirety.

### BACKGROUND

This disclosure relates generally to design and fabrication of integrated circuits, and more specifically to power supply networks in integrated circuits.

In certain integrated circuits, power is distributed to the electronic components, such as logic gates, through one or more networks of conductors. Such networks are sometimes referred to as “power grids.” Various aspects of a power grid design may affect the performance of an integrated circuit. Efforts are ongoing in designing power grids to optimize the

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is an example of a clock tree (clock pulse delay map) for an integrated circuit device.

FIG. 1B shows a thermal emission, or IR-drop, distribution map of the integrated circuit device that generates the clock tree of FIG. 1A. IR-drop hot spots are identified for targeted power grid according to some embodiments.

FIG. 1C shows an enlarged view of the portion in the vicinity of the IR-drop hotspots. A high-tagging cell responsible for the IR-drop hotspots is identified for targeted power grid according to some embodiments.

FIG. 2A illustrates an implementation of targeted power grid according to some embodiments.

FIG. 2B schematically shows a targeted power grid implementation for a cell in an integrated circuit according to some embodiments.

FIG. 2C schematically shows a dedicated power grid path for a high-tagging cell according to some embodiments.

FIG. 3 schematically shows targeted power grid implemented for two standard cells in an integrated circuit according to some embodiments.

FIGS. 4 schematically shows a standard cell provided with targeted power grid in an integrated circuit according to some embodiments.

FIG. 5A schematically illustrates a view from the top of a targeted power grid provided to a cell according to some embodiments.

FIG. 5B schematically illustrates a close-up view of a portion of the targeted power grid illustrated in FIG. 5A according to some embodiments.

FIG. 5C schematically illustrates a three-dimensional view of the targeted power grid illustrated in FIG. 5A from one power supply line according to some embodiments.

FIG. 5D schematically illustrates zones of different average power grid densities in an integrated circuit device according to some embodiments.

FIG. 6A shows the targeted power grid for a standard cell as shown in FIG. 4, with details of the standard cells in the integrated circuit omitted, according to some embodiments.

FIG. 6B shows the lowest three metal layers M1-M3 of the targeted power grid shown in FIG. 6A, with the metal layers (M4-M8) omitted, according to some embodiments.

FIG. 6C shows metal layers M4-M6 of the targeted power grid shown in FIG. 6A, with the remaining metal layers (M1-M3, M7-M8) omitted, according to some embodiments.

FIG. 6D shows metal layers M7-M8 of the integrated circuit shown in FIG. 6A, with the remaining metal layers (M1-M6) omitted, according to some embodiments.

FIG. 7A schematically shows targeted power grid using single conductive row according to some embodiments.

FIG. 7B schematically shows targeted power grid using two conductive rows according to some embodiments.

FIG. 7C schematically shows targeted power grid using three conductive rows according to some embodiments.

FIG. 8A shows an example of an integrated circuit device with targeted power grid using a single conductor row.

FIG. 8B shows an example of an integrated circuit device with targeted power grid using two conductive rows.

FIG. 9 shows an example of an integrated circuit device with targeted power grid in accordance with some embodiments.

FIG. 10 schematically shows an automated placement routing flow with targeted power grid in accordance with some embodiments.

FIG. 11A outlines a method of designing an integrated circuit device according to some embodiments.

FIG. 11B outlines a method of making an integrated circuit device according to some embodiments.

FIG. 12 schematically shows a computer system programmed to provide targeted power grid according to some embodiments.

FIG. 13 schematically shows an integrated circuit manufacturing system according to some embodiments.

FIG. 14 shows improvements in power, performance, and area (PPA) for an integrated circuit according to some embodiments.

FIG. 15 shows an example of reduction in IR loss by using targeted power grid.

### DETAILED DESCRIPTION

The following disclosure provides different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In certain integrated circuits (ICs), power is distributed to the electronic components, which may be organized as functional units, or cells (e.g., standard cell), such as logic gates, through one or networks of conductors. Such networks are sometimes referred to as “power grids” (“PGs”). In certain ICs, the power grid includes multiple layers of conductive (e.g., metal) lines above (or below) the active layer, i.e., the semiconductor layer in which the active regions of the devices are formed. Certain conductive lines in neighboring layers can be connected to each other by conductive pillars (or vias) so that electrical power can be delivered from a layer (e.g., the top layer) to the active layer through the intervening conductive layers and vias. As the conductive material(s) of the conductive lines and vias has finite resistivity, there is a voltage loss, often referred to as “IR drop,” from the point of power supply line to the active layer. Typically, the greater the current a cell uses, the greater IR drop to that cell. The IR drops in certain instances such as the case of some high-driving strength clock buffer cells, can be significant enough to adversely affect the performance of the cells. It is possible in some cases to reduce IR-drops by increasing the density of power grid. The PG density can be increased by increasing the number or cross-sectional areas of conductive paths, e.g., by increasing the widths of the conductive lines and/or vias. However, doing so can lead to more severe constraints on the placement and routing of the cells, resulting in increased violations of design rules (e.g., an increase in the design rule check (DRC) violation number). Performance (speed) of the integrated circuit device may also be negatively impacted, or enhancement of performance (for example, with increased utilization) hindered, due at least in part to circuit capacitance increase.

It is noted that significant IR drops based on conventional designs are localized in many instances, i.e., often mostly limited to certain cells, such as high driving strength clock buffer cells, that draw large currents, or have significantly high power consumption than other cells. These locations draw large currents and can be referred to as “IR-drop hotspots.” Increasing the PG density throughout the entire integrated circuit device can thus unnecessarily increase the ill effects described above. Instead of increasing the density of the entire PT grid, in some embodiments, localized low-resistance paths are provided between IR-drop hotspots and conductive lines (e.g., power supply lines) remote from the IR-drop hotspots. In some embodiments, such localized low-resistance paths are dedicated paths, i.e., electrically isolated from conductive paths to other cells, except at the layer (e.g., top metal layer) of the common power supply.

In some embodiments, a low-resistance path between an active cell and a power supply layer in an integrated circuit device includes at least one layer of a plurality of conductive lines commonly connected to at least one conductive line through a plurality of respective conductive pillars, the at least one conductive line being in the power supply layer or intervening the active cell and the power supply layer. In some embodiments, the integrated circuit device includes a conductive layer that includes the plurality of conductive lines and additional conductive portions, where the plurality of conductive lines are isolated from the additional conductive portions.

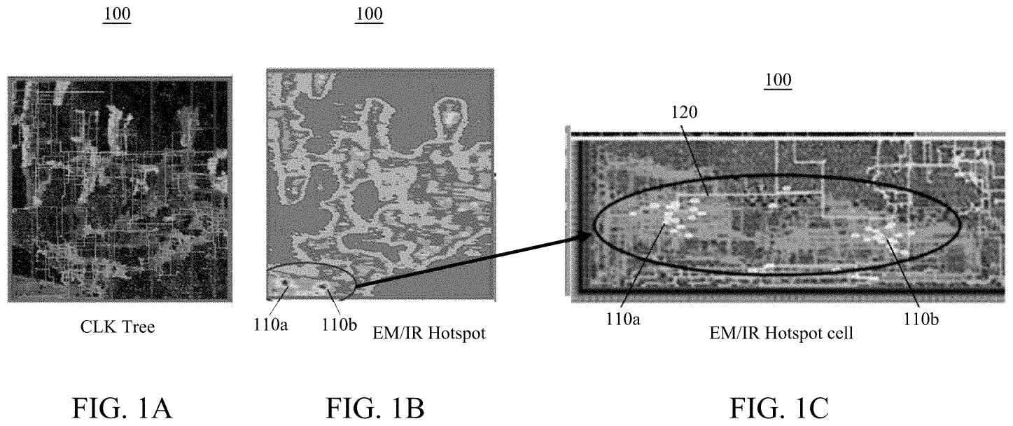

In some embodiments, as shown in FIGS. 1A-1C, IR-drop hotspots can be identified by computer simulation after certain steps in conventional circuit layout design process for an integrated circuit 100 has been completed. For example, IR-drop hotspots can be identified after a clock tree synthesis step has been completed (FIG. 1A). Computer simulation can be run to map IR drop for the integrated circuit device 100, for example, under certain operating conditions, such as at 100% active rate (FIG. 1B). From the mapping, IR hotspots 100a, 100b can be identified, and the cell(s) 120 associated with the IR hotspots 100a, 100b can be identified.

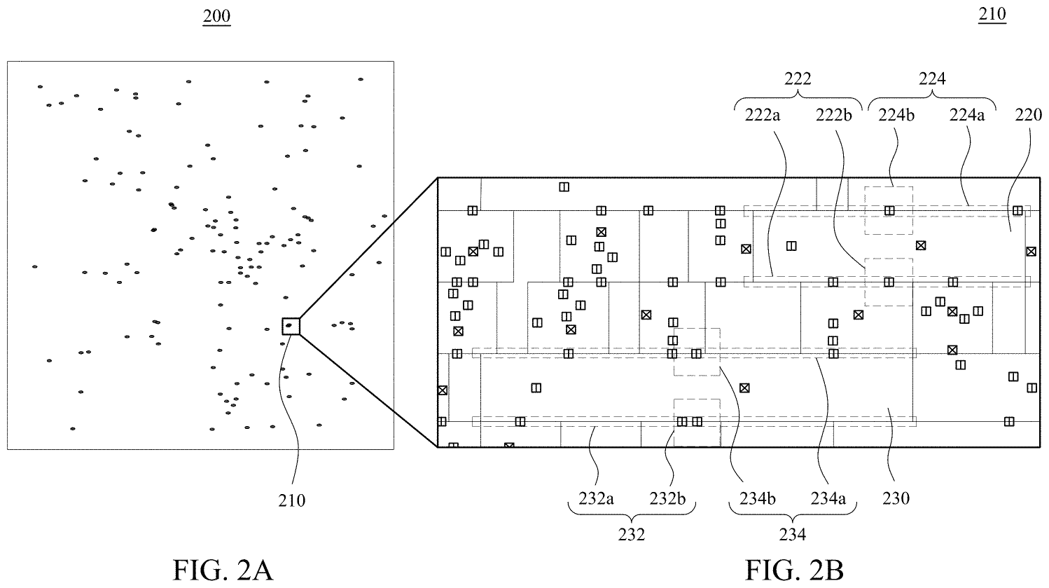

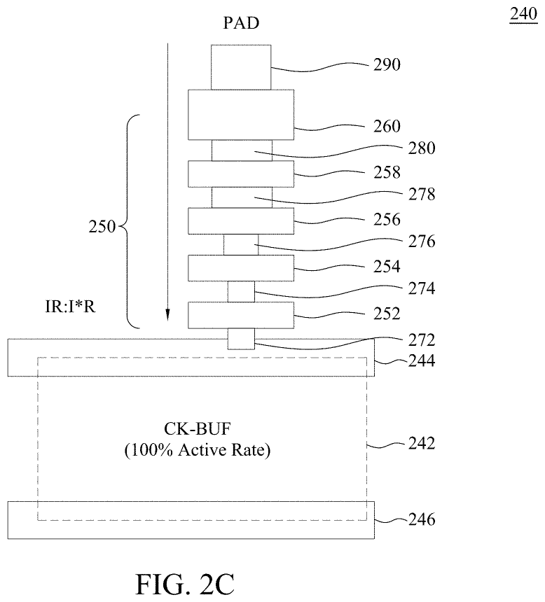

In some embodiments, as shown in FIGS. 2A and 2B, after IR-drop hot points 210 and the cells 220, 230 are identified, low-resistance paths 222, 224, 232, 234 are provided. For example, low-resistance path 222 in the embodiment shown in FIG. 2B includes a first group of one or more metal portions 222a in one or more layers (in this example one layer, M2) and a second group of one or more metal portions 222b in one or more layers (in this example five players, M3-M7); low-resistance path 224 in the embodiment includes a first group of one or more metal portions 224a in one or more layers (in this example one layer, M2) and a second group of one or more metal portions 224b in one or more layers (in this example five players, M3-M7); low-resistance path 232 in the embodiment includes a first group of one or more metal portions 232a in one or more layers (in this example one layer, M2) and a second group of one or more metal portions 232b in one or more layers (in this example five players, M3-M7); and low-resistance path 234 in the embodiment includes a first group of one or more metal portions 234a in one or more layers (in this example one layer, M2) and a second group of one or more metal portions 234b in one or more layers (in this example five players, M3-M7). Each metal portion layer 222a, 222b, 224a, 224b, 232a, 232b, 234a, 234b of layer M2-M7 in some embodiments includes one or more metal lines, and at least one of metal portions in layers M3-M7 includes multiple metal lines, as described in more detail below. The metal lines in neighboring layers are connected to each other by conductive pillars, or vias (not shown in FIG. 2B).

In some embodiments, as shown in FIG. 2C, in an integrated circuit device 240 having an IR-hotspot cell with an active region 242 (in this example a clock buffer) and power rails 244, 246, a low-resistance path 250 between a power supply path 290 and a power rail 244 includes metal portions 252, 254, 256, 258, 260, at least one of which includes multiple metal lines. Each of the metal portions 252, 254, 256, 258, 260, and power rail 244 is connected to its neighboring metal portions 252, 254, 256, 258, 260 by a group of one or more metal pillars, or vias, 272, 274, 276, 278, 280; at least one of the groups of one or more metal pillars 272, 274, 276, 278, 280 includes multiple metal pillars. In some embodiments, at least some of the metal portions 252, 254, 256, 258, 260 are parts of respective metal layers but are isolated from the remainder of the respective metal layers. As a result, in some embodiments, dedicated conductive paths are formed between a power supply line and power rails of certain cells. For example, in the example shown in FIG. 2C, metal portions 252, 254, 256, 258, 260 are each isolated from the remainder of the respective metal layers they are in and, together with the metal pillars 272, 274, 276, 278, 280, form a dedicated conductive path between the pad 290 and the power rail 244.

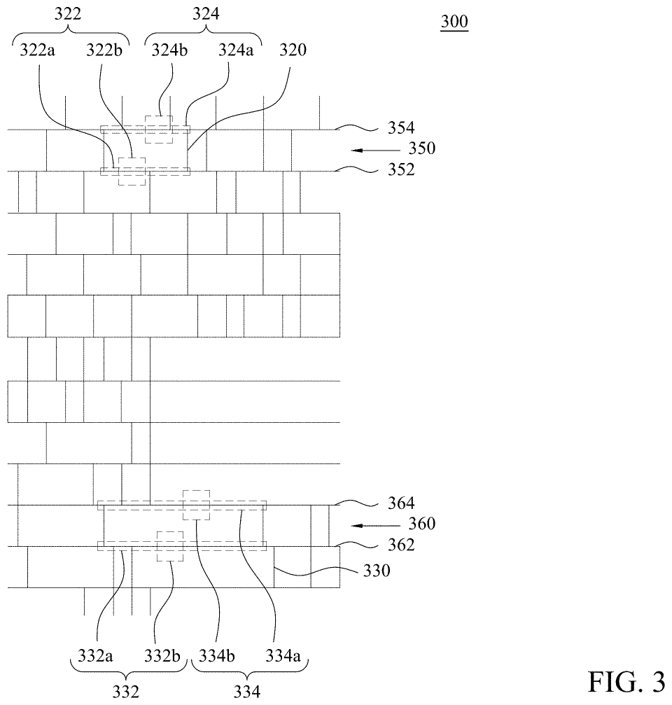

As another example, shown in FIG. 3, dedicated conductive paths 322, 324 are formed for cell 320 in a row of cells 350 of the integrated circuit device 300; and dedicated conductive paths 332, 334 are formed for cell 330 in a row of cells 360. Dedicated conductive path 322 includes metal portions 322a, 322b; the metal portion 322a can be formed in the same layer as a metal line 352 along the cell row 350 but is isolated from the remainder of the metal line 352, for example by a metal cut; likewise, dedicated conductive path 324 includes metal portions 324a, 324b; the metal portion 324a can be formed in the same layer as a metal line 354 along the cell row 350 but is isolated from the remainder of the metal line 354. Similarly for cell 330 in the cell row 360, dedicated conductive path 332 includes metal portions 332a, 332b; the metal portion 332a can be formed in the same layer as a metal line 362 along the cell row 360 but is isolated from the remainder of the metal line 362; likewise, dedicated conductive path 334 includes metal portions 334a, 334b; the metal portion 334a can be formed in the same layer as a metal line 364 along the cell row 360 but is isolated from the remainder of the metal line 364. As shown in certain examples below, such dedicated conductive path can provide low-resistance conductive power grid paths to targeted cells, leaving the PG configuration for the remaining cells largely unaffected.

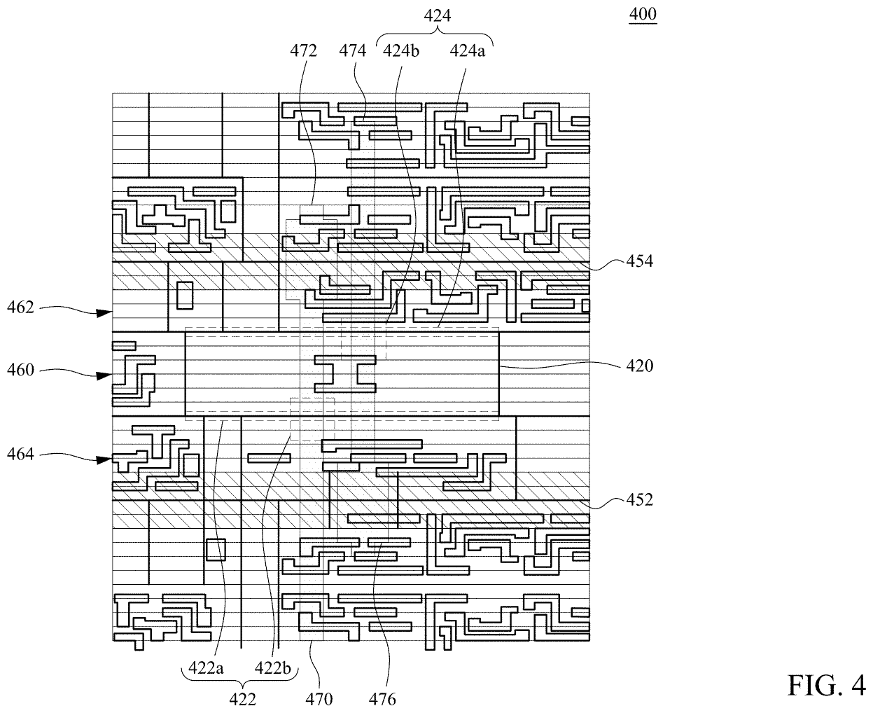

A low-resistance path, such as those shown in FIG. 3, can be connected to other parts of an integrated circuit device in any suitable manner. For example, in some embodiments, one end of a low-resistance path is connected to a power supply line directly above it by conductive pillars. In other embodiments, such as the one shown in FIG. 4, a low-resistance path can be connected to a power supply line that is laterally offset from the low-resistance path through one or more intervening layers of conductive lines. In the example integrated circuit device 400 shown in FIG. 4, the cell 424 targeted power grid is located in a row 460 between neighboring rows 462, 464; the power supply lines VDD 452 and VSS 454 are located above the edges of rows 462 (including multiple layers 422a,422b), 464 (including multiple layers 424a, 424b), respectively, away from the targeted cell 420 and are thus laterally offset from the low-resistance path 422, 424, respectively. In this example, an intervening layer of conductive lines 470 (including a widened portion 472), 474 (including a widened portion 476), together with associated metal pillars (not shown), connects the upper-end conductive layers in the-resistance paths 422, 424 to the power supply lines VDD 452 and VSS 454, respectively.

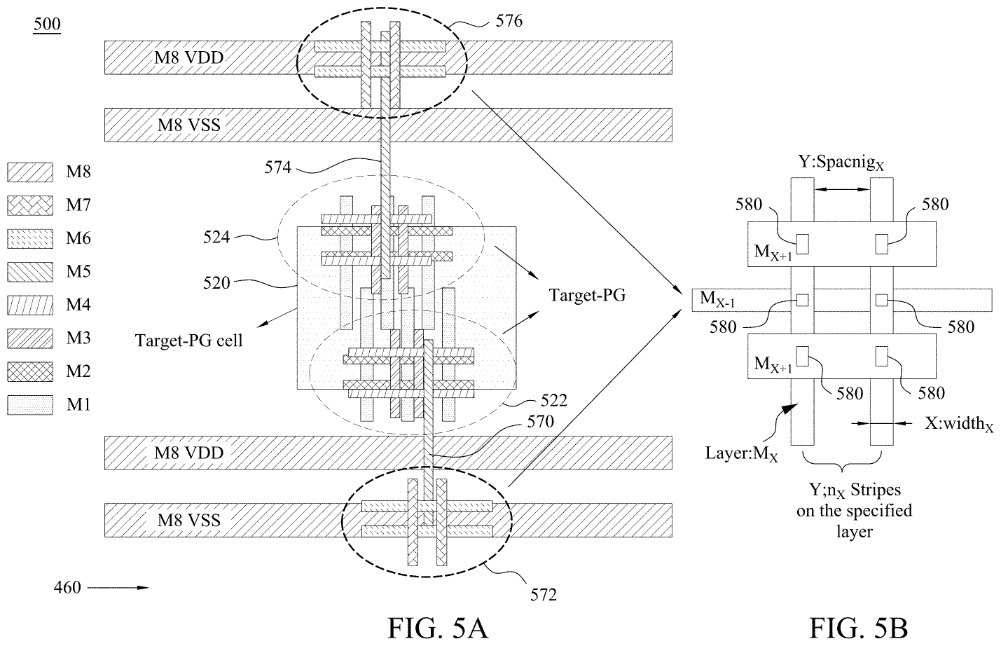

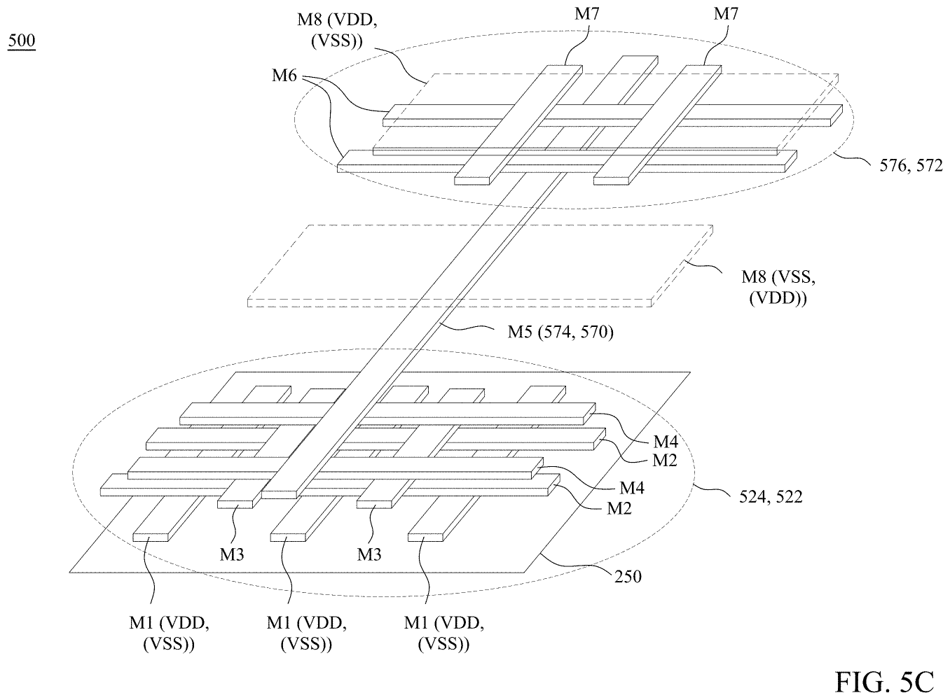

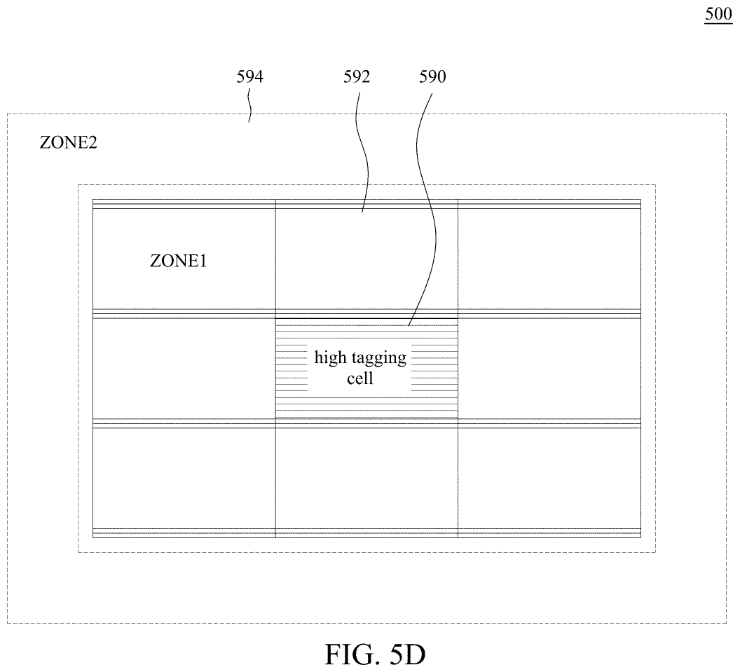

In other embodiments, such as the one shown in FIGS. 5A-5C, low-resistance paths for a cell 520 for targeted power grid in an integrated circuit device 500 include multiple low-resistance portions laterally offset from each other, each portion including multiple layers of conductive lines. As illustrated in a top view in FIG. 5A and perspective view in FIG. 5C (which illustrates the portion corresponding to the top half of FIG. 5A, or bottom half FIG. 5A viewed from the opposite direction), each low-resistance path between the active layer of the cell 520 and the respective power supply line M8 (VDD or VSS) includes two low-resistance portions: a lower portion 522, 524, which includes layers M1 (VSS side for lower portion 522; VDD side for lower portion 524) through M4 of conductive lines, and an upper portion 572, 574, which includes layers M6 and M7. A layer M5 of metal lines 570, 574 intervenes between layers M4 and M6. The conductive lines in neighboring metal layers are connected to each other by metal pillars, or vias, 580 (FIG. 5B). Likewise, the top metal layer M7 is connected to the power supply line M8 (VSS or VDD) by metal pillars 580; the bottom layer M1 is connected to the power rails (VSS or VDD) for the targeted cell 520 by metal pillars 580.

As shown in FIGS. 5A-5C, the number of conductive lines in each layer M1-M7 can vary. In this specific example the number of conductive lines in layers M1-M7 on each side (VSS or VDD) are 3, 2, 2, 2, 1, 2, and 2, respectively. The numbers of conductive pillars 580 (FIG. 5B) interconnecting the conductive lines in neighboring layers M1-M7 are thus 6, 4, 4, 2, 2, 4, respectively. Additionally, three conductive pillars 580 connect the conductive lines in M1 to the cell 520, and at least two conductive pillars 580 connect the conductive lines in M7 to the power supply line M8 (VSS or VDD). In each case, the number of conductive paths between any given two layers is at least 2. The total resistance, which is correlated to the IR-drop, of the conductive path between M8 and the targeted cell 520 is thus lower as comparted to the power grid configuration in which the conductive path is made of a series of single conductive lines and pillars.

In this embodiment, the conductive paths connecting the cell 520 to the power supply lines M8 are dedicated paths: The conductive line segments in the lower portions 522, 524 (M1-M4) and upper portions 572, 576 (M6-M7), as well as the preaching lines 570, 574, of the conductive paths are separated from other conductive lines, for example by metal cuts, in the same respective players. For example, the two conductive line segments in metal layer M3 and in the lower portion 524 of the conductive path to the power rail VDD are each isolated from all other conductive portions of metal layer M3, although these conductive line segments may be ultimately electrically connected to other conductive portions of metal layer M3 by the virtue of their common connection to VDD power supply line M8. Dedicated conductive paths from both to supply lines to targeted cells serve to reduce IR-drop for the targeted cells without unnecessarily increasing the power grip density for the entire integrated circuit device.

As a result of the configuration of low-resistance paths described above, power grid density, i.e., areal density of the conductive lines and/or conductive pillars is significantly higher at or near the targeted, or high-tagging, cells, which have significantly higher power consumption, or current, than other cells. High-tagging cells in some embodiments are cells that are expected to operate at higher current levels then other cells. Examples of high-tagging cells include high-driving strength clock buffer cells. In some embodiments, as shown in FIG. 5D, the power grid density for an integrated circuit device 500 is significantly higher (e.g., twice as high) in a zone, Zone1 592, centered at the targeted cell 590 and about one cell width and height beyond the targeted cell 590, than in a zone, Zone2 594, beyond Zone1 592.

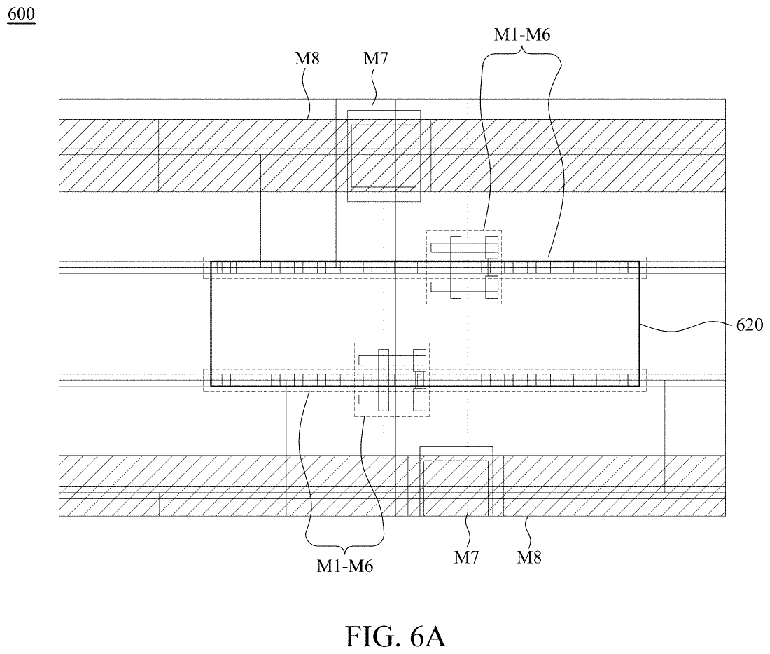

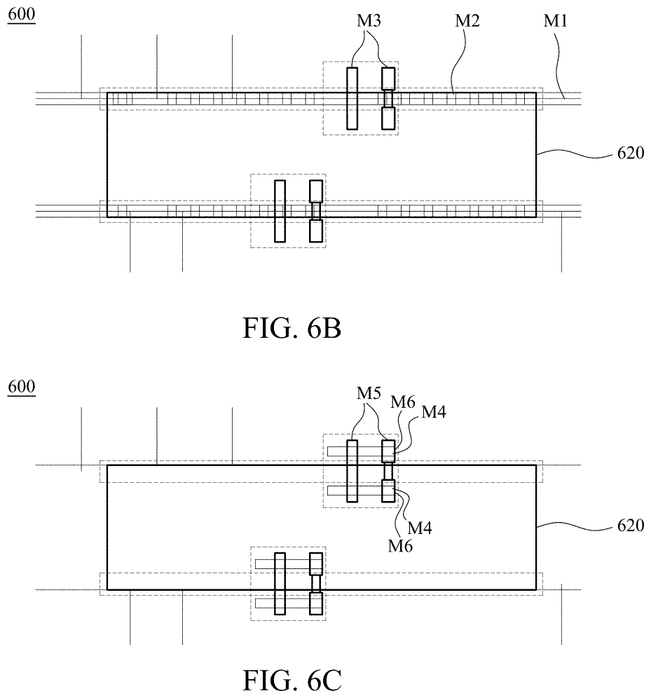

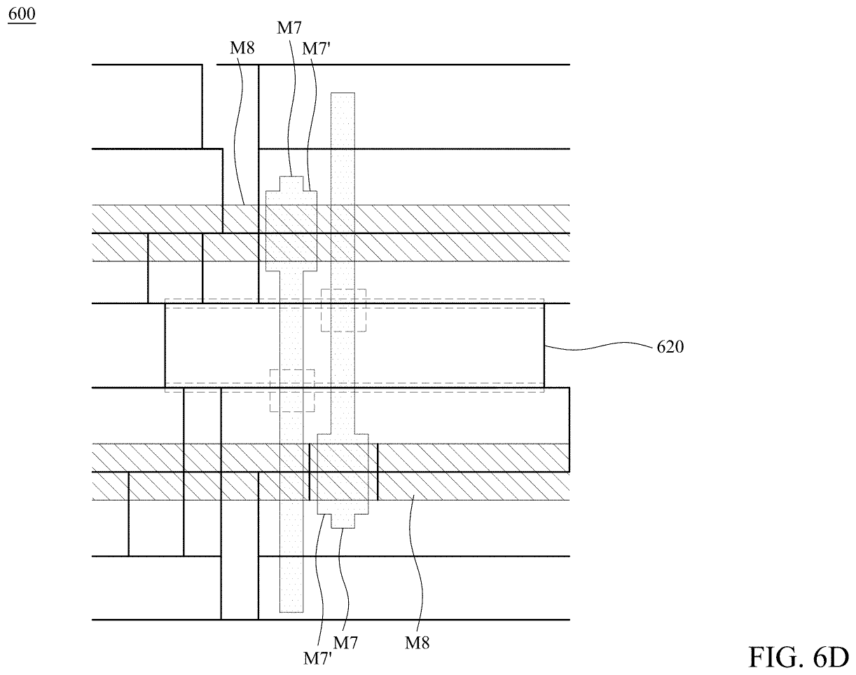

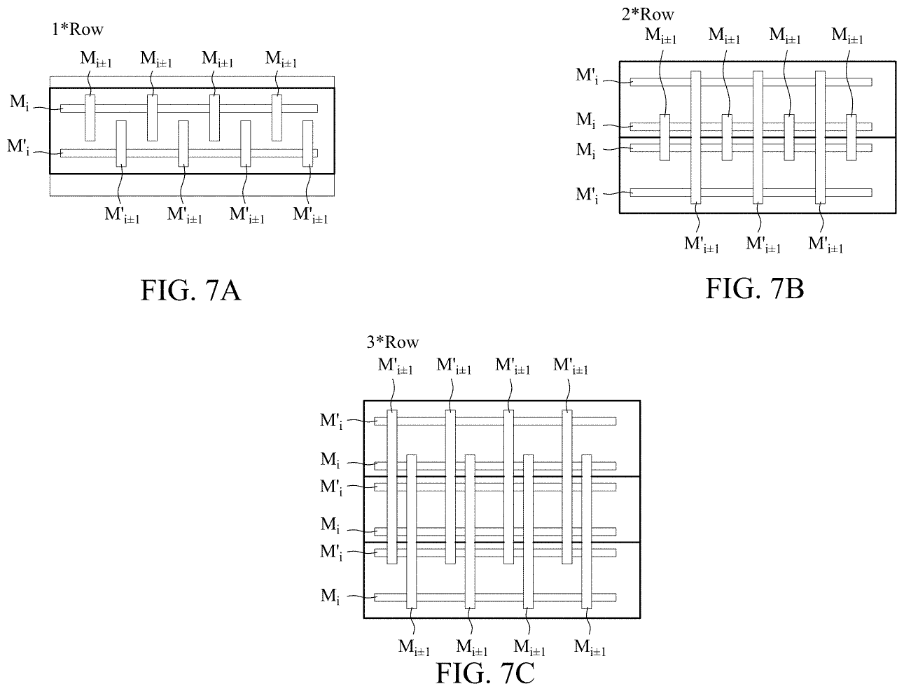

An example of targeted power grid is shown in FIGS. 6A-6D. FIG. 6A shows an integrated circuit device 600, with a high-tagging cell 620 provided with targeted power grid. The reduced-resistance paths to the cell 620 each includes metal layers M1-M8, including the power rails M1, power supply lines M8, and intervening metal layers M2-M7. In this example embodiment, as shown more clearly in FIG. 6B, which shows only layers M1-M3 for clarity, the first (lowest) metal layer M1, which in some embodiments are the power rails for the row of cells the high-tagging cell 620 is a part of, extends along the boundaries between the rows of cells (i.e., in the x-direction). The conductive lines in the next layer M2 are positioned directly above, and parallel with, the conductive lines in M1 and connected to the conductive lines in M1 by metal pillars (not shown). The conductive lines in the next layer M3 extend transverse to the conductive lines in M2 and are connected to the conductive lines in M3 by metal pillars (not shown).

As shown more clearly in FIG. 6C, which shows only layers M4-M6 for clarity, the conductive lines in the fourth metal layer M4 (obscured by the sixth layer M6) extend in the x-direction and are connected to the metal layer M3 below by metal pillars (not show). The conductive lines in the next layer M5 above M4 extend transverse to the conductive lines in M4 and are connected to the conductive lines in M4 by metal pillars (not shown). The conductive lines in the next layer M6 extend transverse to the conductive lines in M5 and are connected to the conductive lines in M5 by metal pillars (not shown).

As shown more clearly in FIG. 6D, which shows only layers M7 and M8 for clarity, the conductive lines in the seventh metal layer M7 extend in the x-direction and are connected to the metal layer M6 below by metal pillars (not shown). Each metal line M7 in this example embodiment includes a widened portion M7′. The conductive lines in the top layer M8, which are laterally offset from the low-resistance path comprised of the conductive lines in metal layers M1-M6, and in some embodiments are power supply lines VSS or VDD, extend transverse to the conductive lines in M7 and are connected to the conductive lines in M7 at the widened portions M7′ by metal pillars (not shown).

In general, low-resistance paths for a targeted power grid are in some embodiments constructed by having a localized (such as in a zone centered at a high-tagging cell within about a width and height of the high-tagging cell, as indicated in FIG. 5D) higher areal density of conductive lines and/or conductive pillars in at least one conductive layer in an integrated circuit device, thereby reducing the IR-drop associated with the respective segment of the power grid. For example, as illustrated in FIG. 1A, in some embodiments, multiple conductive lines M_{i±1} can be disposed in a layer adjacent (above or below) the ith conductive layer and be connected to a conductive line Mᵢ in the ith layer via conductive pillars (not shown). Likewise, multiple conductive lines M′_{i±1} can be disposed in a layer adjacent (above or below) the ith conductive layer and be connected to a conductive line M′ᵢ in the ith layer via conductive pillars (not shown). As illustrated in FIG. 1B, in other embodiments, multiple conductive lines M_{i±1}can be disposed in a layer adjacent (above or below) the ith conductive layer and be each connected to two conductive lines Mᵢ in the ith layer via conductive pillars (not shown). Likewise, multiple conductive lines M′_{i±1} can be disposed in a layer adjacent (above or below) the ith conductive layer and be each connected to two conductive lines M′ᵢ in the ith layer via conductive pillars (not shown). As illustrated in FIG. 1C, in further embodiments, multiple conductive lines M_{i±1} can be disposed in a layer adjacent (above or below) the ith conductive layer and be each connected to three conductive lines Mᵢ in the ith layer via conductive pillars (not shown). Likewise, multiple conductive lines M′_{i±1} can be disposed in a layer adjacent (above or below) the ith conductive layer and be each connected to three conductive lines M′ᵢ in the ith layer via conductive pillars (not shown).

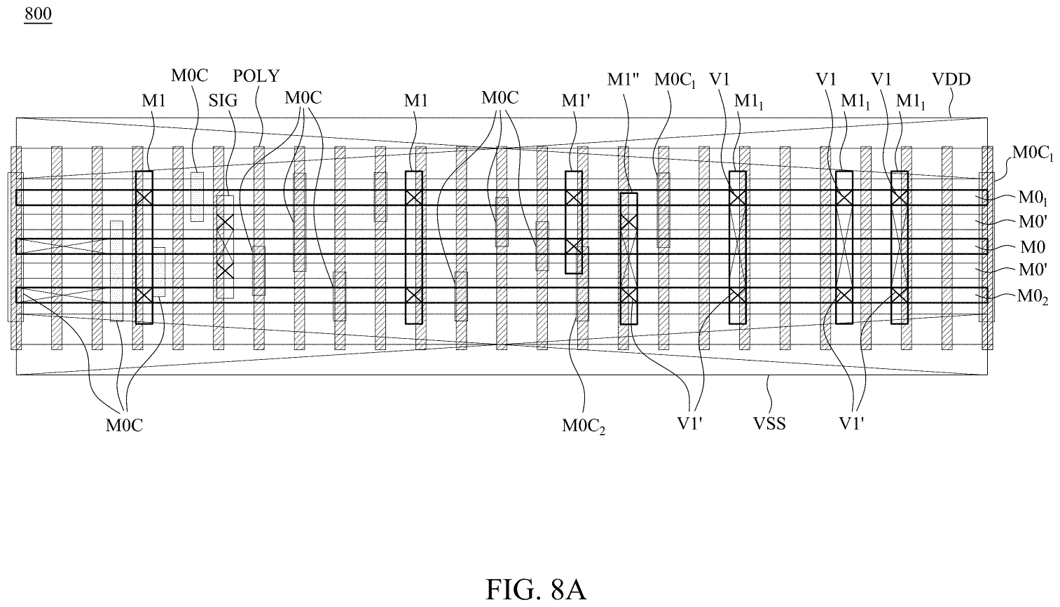

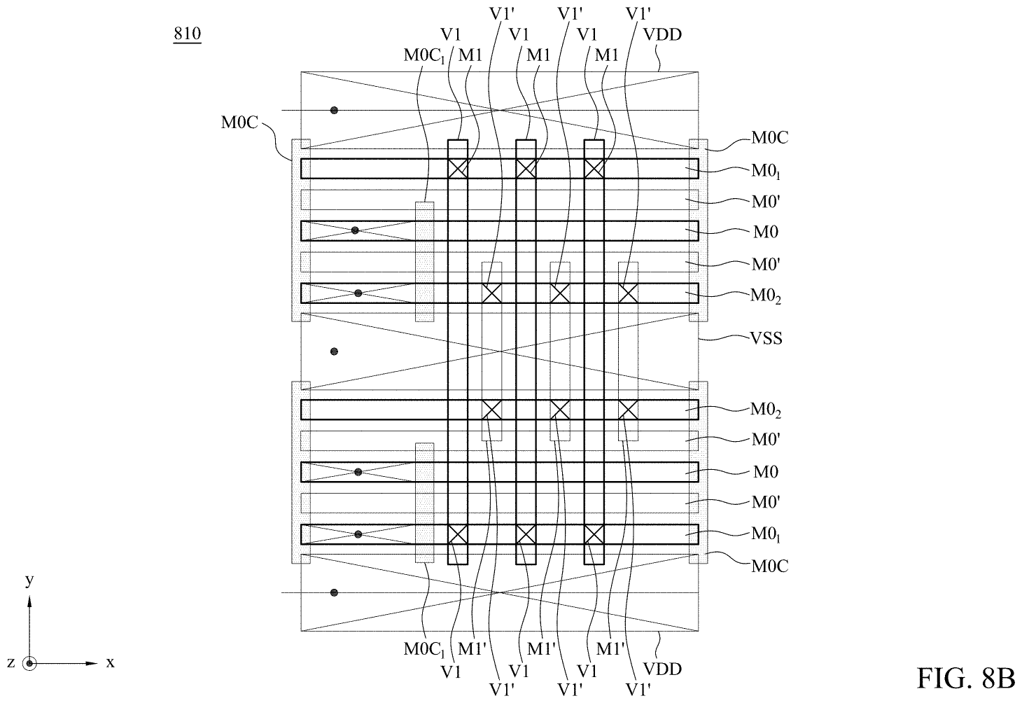

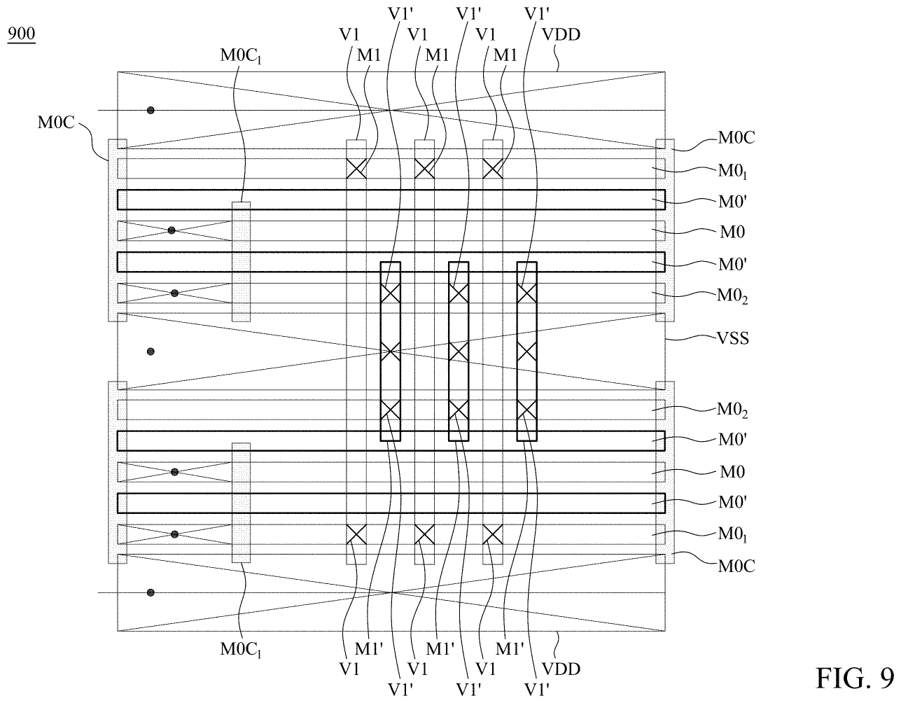

An example portion of an integrated circuit device 800 with a targeted power grid structure having multiple conductive lines connected to a single conductive line is shown in FIG. 8A. In this embodiment, the integrated circuit device 800 includes polysilicon lines POLY extending in the y-direction. Above the polysilicon lines POLY is a first layer of conductive lines M0, M0₁, M0₂, M0′ extending along the x-direction; above the first layer of conductive lines is a second layer of conductive lines, including power grid lines M1, M1₁, M1′, M″ and signal output lines SIG, all extending in the y-direction. The conductive lines in the first layer are interrupted by metal cuts M0C, M0C₁, M0C₂. One segment of a conductive line M0₁ between two metal cuts M0C₁ in the first layer is connected to multiple (in this example three) conduct line segments M1₁ in the second layer by conductive pillars V1. Likewise, one segment of a conductive line M0₂ between two metal cuts M0C₁, M0C₂ in the first layer is connected to multiple (in this example four) conduct line segments M1₁, M1″ in the second layer by conductive pillars V1′.

Another example portion of an integrated circuit device 810 with a targeted power grid structure having multiple conductive lines connected to multiple conductive lines is shown in FIG. 8B. In this embodiment, the integrated circuit device 810 includes a first layer of conductive lines M0, M0₁, M0₂, M0′ extending along the x-direction; above the first layer of conductive lines is a second layer of conductive lines, including power grid lines M1, M1′. The conductive lines in first layer are interrupted by metal cuts M0C, M0C₁. The two conductive lines M0₁ in the first layer are connected to multiple (in this example three) conduct line segments M1 in the second layer by conductive pillars V1. Likewise, two conductive lines M0₂ in the first layer are connected to multiple (in this example three) conduct line segments M1″ in the second layer by conductive pillars V1′. An integrated circuit device 900 similar to that shown in FIG. 8B is shown in FIG. 9.

The device 900 is otherwise identical to the integrated circuit device 800 except that instead of three conductive lines M1 in the second layer, an integrated circuit device 900 as for conductive lines M1 connected to the two conductive lines M0₁ in the first layer by eight conductive pillars V1.

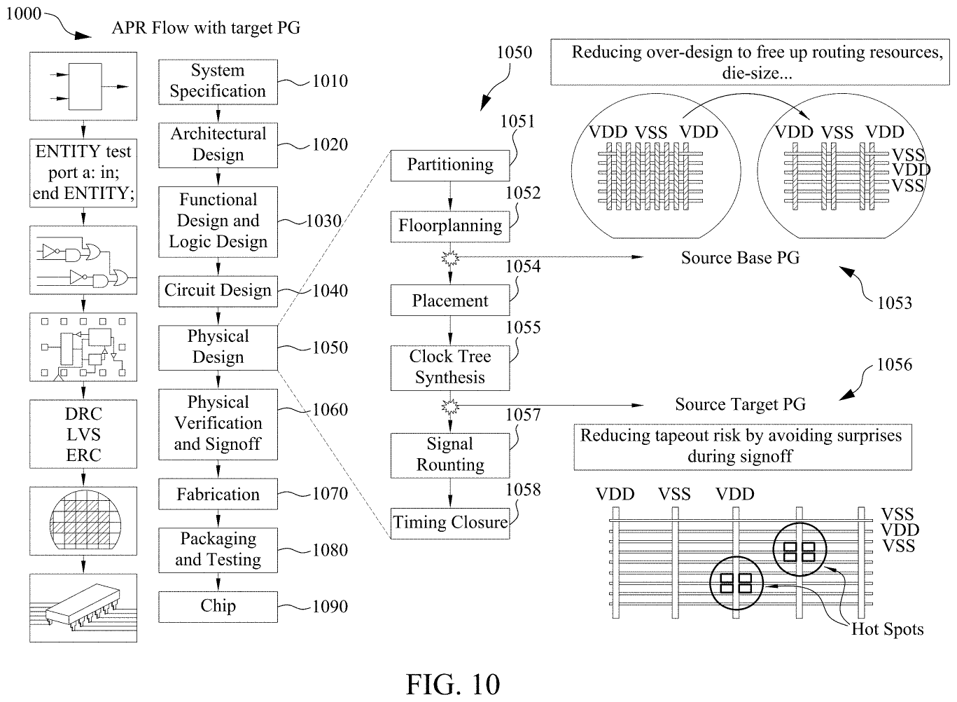

In some embodiments, a targeted power grid, some embodiments of which are described above, is designed in an integrated circuit design process, such as automated placement and routing (APR). An example of a chip manufacturing process 1000 that includes an APR process with targeted power grid is outlined in FIG. 10. The process 1000 includes, in order, system specification 1010, architectural design 1020, functional design and logic design 1030, circuit design 1040, physical design 1050, physical verification and signoff 1060, fabrication 1070, packaging and testing 1080, and completion of manufacturing 1090. The physical design process 1050 in some embodiments includes, in order, partitioning 1051, floorplanning 1052, placement 1054, clock tree synthesis 1055, signal routing 1057, and timing closure 1058. During the physical design 1050, conventional power grid layout 1053 is carried out between floorplanning 1052 and a placement 1054. In this step 1053, the power grid is laid out without regard to any IR-drop hotspot. After clock tree synthesis 1055 but before signal routing 1057, the conventional power grid is modified 1056 to create a targeted power grid, in which low-resistance paths between the power supply lines (VSS and/or VDD) to high-tagging cells are constructed in the design.

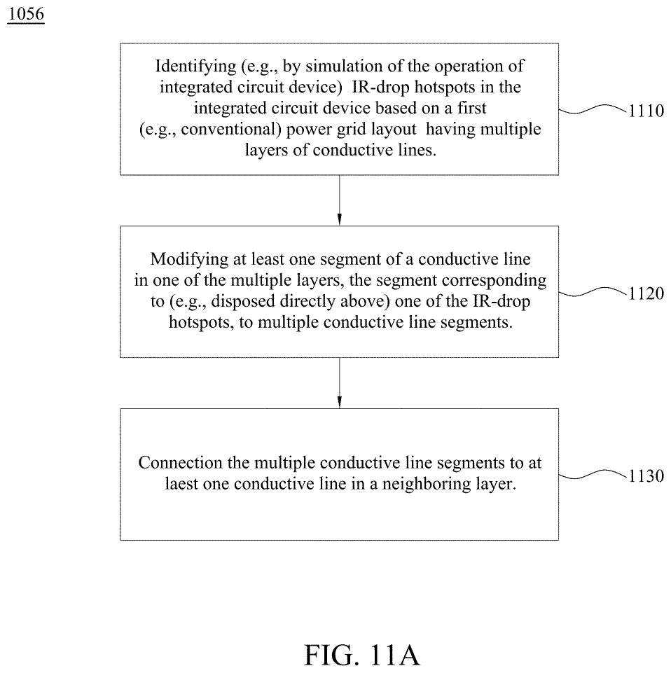

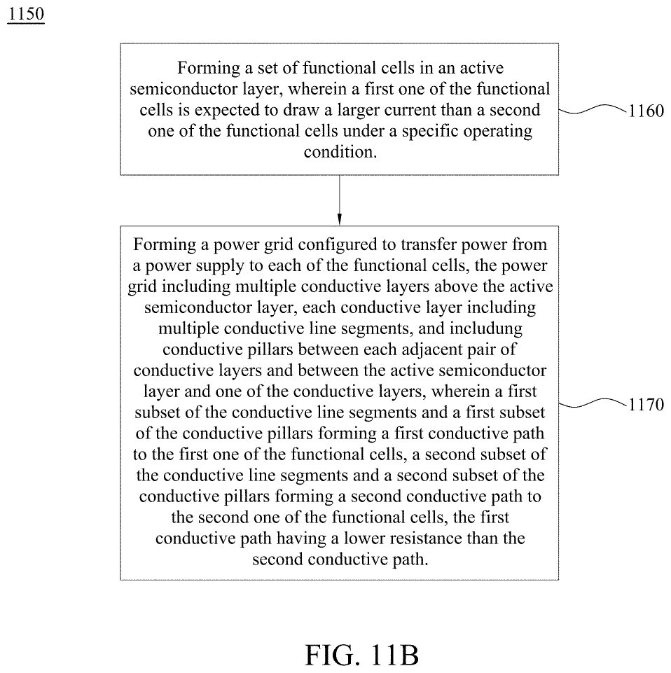

In some embodiments, as outlined in FIG. 11A, targeted power grid design 1056 for an integrated circuit device having a power grid that includes multiple layers of conductive lines includes: identifying 1110 (e.g., by simulation of the operation of integrated circuit device) IR-drop hotspots in the integrated circuit device based on a first (e.g., conventional) power grid layout; modifying 1120 at least one segment of a conductive line in one of the multiple layers, the segment corresponding to (e.g., disposed directly above) one of the IR-drop hotspots, to multiple conductive line segments; and connecting 1130 the multiple conductive line segments to at least one conductive line in a neighboring layer, thereby constructing a conductive path between a power supply line and a semiconductor device, with a reduced IR-drop between the power supply line and the semiconductor device as compared with the IR-drop produced by the first power grid layout. It is noted that in the process outlined above, each step is performed not on any physical structure, such as metal layers in an integrated circuit device, but on features resulting from certain steps in a physical design process for integrated circuits.

In some embodiments, as outlined in FIG. 11B, a process 1150 for making an integrated circuit device includes forming 1160 a set of functional cells in an active semiconductor layer, wherein a first one of the functional cells is expected to draw a larger current than a second one of the functional cells under a specific operating condition; and forming 1170 a power grid configured to transfer power from a power supply to each of the set of functional cells, the power grid including multiple conductive layers above the active semiconductor layer, each conductive layer including multiple conductive line segments, and including conductive pillars between each adjacent pair of conductive layers and between the active semiconductor layer and one of the conductive layers, wherein a first subset of the conductive line segments and a first subset of the conductive pillars forming a first conductive path to the first one of the functional cells, a second subset of the conductive line segments and a second subset of the conductive pillars forming a second conductive path to the second one of the functional cells, the first conductive path having a lower resistance than the second conductive path.

In some embodiments, the integrated circuit device design with targeted power grid is used in subsequent steps in the process 1000, including fabrication 1070 and packaging and testing 1080, to make 1090 an integrated circuit device.

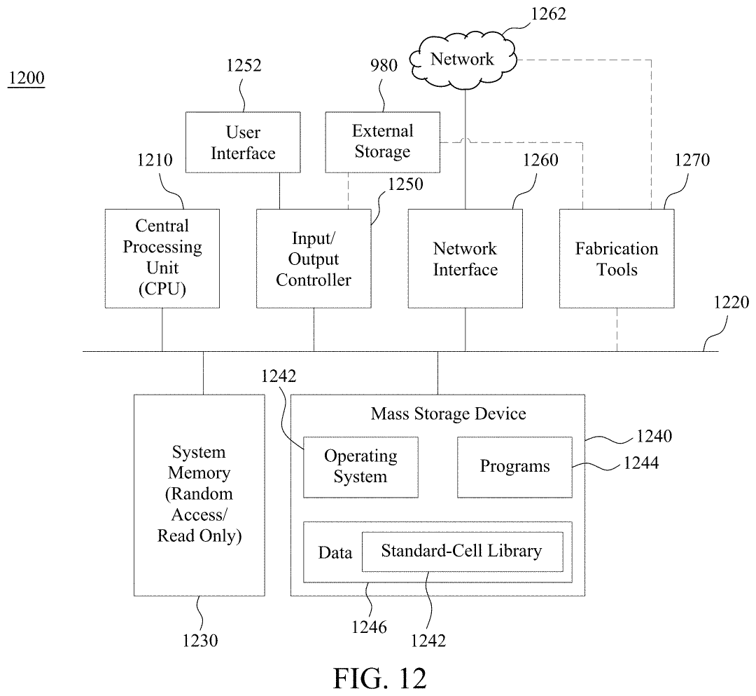

As mentioned above, the processes described above for designing targeted power grid, and/or manufacturing integrated circuits with targeted power grid, are carried out in some embodiments by a computer system, such as a computer system having electronic design automation (EDA) tools for automated placement and routing of devices. Such a computer system in some embodiment includes one or more special-purpose computers, which can be one or more general-purpose computers specifically programmed to perform the methods. For example, a computer 1200 schematically shown in FIG. 12 can be used. The computer 1200 includes a processor 1210, which is connected to the other components of the computer via a data communication path such as a bus 1220. The components include system memory 1230, which is loaded with the instructions for the processor 1210 to perform the methods described above. Included is also a mass storage device, which is a computer-readable storage medium 1240. The mass storage device is an electronic, magnetic, optical, electromagnetic, infrared, and/or a semiconductor system (or apparatus or device). For example, the computer-readable storage medium 1240 includes a semiconductor or solid-state memory, a magnetic tape, a removable computer diskette, a random access memory (RAM), a read-only memory (ROM), a rigid magnetic disk, and/or an optical disk. In one or more embodiments using optical disks, the computer-readable storage medium 1240 includes a compact disk-read only memory (CD-ROM), a compact disk-read/write (CD-R/W), and/or a digital video disc (DVD). The mass storage device 1240 stores, among other things, the operating system 1242; programs 1244, including those that, when read into the system memory 1220 and executed by the processor 1210, cause the computer 1200 to carry out the processes described above; and Data 1246. Data 1246 can include, for example, a standard cell library, which includes standard cells, such as NAND, NOR, INV (inverter), AOI (AND-OR-Inverter), and SDFQ (D flip-flop with scan input), design rules, status of the IC circuit design, including the current iteration of mask pattern. The computer 1200 also includes an I/O controller 1250, which input and output to a User Interface 1252. The User Interface 1252 can include a keyboard, mouse, display and any other suitable user interfacing devices. The I/O controller can have further input/out ports for input from, and/or output to, devices such as an External Storage device 1280, which can be any memory device, including a semiconductor or solid-state memory device, a magnetic tape drive, a rigid magnetic disk drive, and/or an optical disk, such as a compact disk-read only memory (CD-ROM), a compact disk-read/write (CD-R/W), and/or a digital video disc (DVD). The computer can further include a network interface 1260 to enable the computer to receive and transmit data from and to remote networks 1262.

The computer system in some embodiments includes a Fabrication Tools module 1270 for layout and physical implementation of the device fabrication as designed at least in part using the processes described above. The Fabrication Tools module 1270 in some embodiments is a part of the computer 1200 and is connected to the bus 1220 and can receive the layout design stored in the Mass Storage device 1240. In other embodiments, the Fabrication Tools module can be a system separate from the computer 1200 but receive the layout design made by the computer 1200 via the Network 1262. In still further embodiments, the Fabrication Tools module can be a system separate from the computer 1200 but receive the layout design made by the computer 1200 from an External Storage device 1280, such as a solid state storage device or an optical disk.

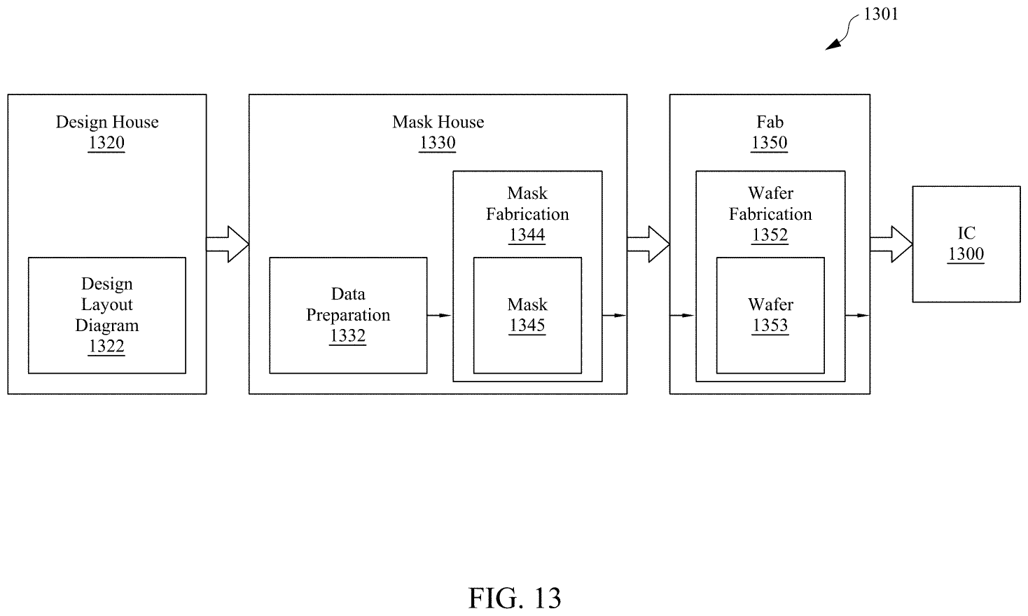

As noted above, the computer system, such as an EDA system (i.e., a computer system with EDA tools) in some embodiments includes fabrication tools 1270 for implementing the processes and/or methods stored in the storage medium 1240. For instance, a synthesis can be performed on a design in which the behavior and/or functions desired from the design are transformed to a functionally equivalent logic gate-level circuit description by matching the design to standard cells selected from the standard cell library 1248. The synthesis results in a functionally equivalent logic gate-level circuit description, such as a gate-level netlist. Based on the gate-level netlist, a photolithographic mask may be generated that is used to fabricate the integrated circuit by the fabrication tools 1270. Further aspects of device fabrication are disclosed in conjunction with FIG. 13, which is a block diagram of IC manufacturing system 1301, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using the manufacturing system 1301.

In FIG. 13, the IC manufacturing system 1301 includes entities, such as a design house 1320, a mask house 1330, and an IC manufacturer/fabricator (“fab”) 1350, that interact with one another in the design, development, and manufacturing cycles and/or services related to manufacturing an integrated circuit (IC) 100, such as the devices disclosed herein. The entities in the system 1301 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of the design house 1320, mask house 1330, and IC fab 1350 is owned by a single entity. In some embodiments, two or more of design house 1320, mask house 1330, and IC fab 1350 coexist in a common facility and use common resources.

The design house (or design team) 1320 generates an IC design layout diagram 1322. The IC design layout diagram 1322 includes various geometrical patterns, or IC layout diagrams designed for an IC device 1300, such as the IC 300 (FIG. 3) discussed above. The geometrical patterns correspond to patterns of metal, oxide, or semiconductor layers that make up the various components of the IC 1300 to be fabricated. The various layers combine to form various IC features. For example, a portion of the IC design layout diagram 1322 includes various IC features, such as an active region, gate electrode, source and drain, metal lines or local vias, and openings for bonding pads, to be formed in a semiconductor substrate (such as a silicon wafer) and various material layers disposed on the semiconductor substrate. The design house 1320 implements a design procedure to form an IC design layout diagram 1322. The design procedure includes one or more of logic design, physical design or place and route. The IC design layout diagram 1322 is presented in one or more data files having information of the geometrical patterns. For example, IC design layout diagram 1322 can be expressed in a GDSII file format or DFII file format.

The mask house 1330 includes a data preparation 1332 and a mask fabrication 1344. The mask house 1330 uses the IC design layout diagram 1322 to manufacture one or more masks 1345 to be used for fabricating the various layers of the IC 1300 according to the IC design layout diagram 1322. The mask house 1330 performs mask data preparation 1332, where the IC design layout diagram 1322 is translated into a representative data file (“RDF”). The mask data preparation 1332 provides the RDF to the mask fabrication 1344. The mask fabrication 1344 includes a mask writer. A mask writer converts the RDF to an image on a substrate, such as a mask (reticle) 1345 or a semiconductor wafer 1353. The design layout diagram 1322 is manipulated by the mask data preparation 1332 to comply with particular characteristics of the mask writer and/or requirements of the IC fab 1350. In FIG. 13, the mask data preparation 1332 and the mask fabrication 1344 are illustrated as separate elements. In some embodiments, the mask data preparation 1332 and the mask fabrication 1344 can be collectively referred to as a mask data preparation.

In some embodiments, the mask data preparation 1332 includes an optical proximity correction (OPC) which uses lithography enhancement techniques to compensate for image errors, such as those that can arise from diffraction, interference, other process effects and the like. The OPC adjusts the IC design layout diagram 1322. In some embodiments, the mask data preparation 1332 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 1332 includes a mask rule checker (MRC) that checks the IC design layout diagram 1322 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1322 to compensate for limitations during the mask fabrication 1344, which may undo part of the modifications performed by OPC in order to meet mask creation rules.

In some embodiments, the mask data preparation 1332 includes lithography process checking (LPC) that simulates processing that will be implemented by the IC fab 1350 to fabricate the IC 1300. LPC simulates this processing based on the IC design layout diagram 1322 to create a simulated manufactured device, such as the IC 1300. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC can be repeated to further refine the IC design layout diagram 1322.

It should be understood that the above description of mask data preparation 1332 has been simplified for the purposes of clarity. In some embodiments, data preparation 1332 includes additional features such as a logic operation (LOP) to modify the IC design layout diagram 1322 according to manufacturing rules. Additionally, the processes applied to the IC design layout diagram 1322 during data preparation 1332 may be executed in a variety of different orders.

After the mask data preparation 1332 and during the mask fabrication 1344, a mask 1345 or a group of masks 1345 are fabricated based on the modified IC design layout diagram 1322. In some embodiments, the mask fabrication 1344 includes performing one or more lithographic exposures based on the IC design layout diagram 1322. In some embodiments, an electron-beam (e-beam) or a mechanism of multiple e-beams is used to form a pattern on a mask (photomask or reticle) 1345 based on the modified IC design layout diagram 1322. The mask 1345 can be formed in various technologies. In some embodiments, the mask 1345 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of the mask 1345 includes a transparent substrate (e.g., fused quartz) and an opaque material (e.g., chromium) coated in the opaque regions of the binary mask. In another example, the mask 1345 is formed using a phase shift technology. In a phase shift mask (PSM) version of the mask 1345, various features in the pattern formed on the phase shift mask are configured to have proper phase difference to enhance the resolution and imaging quality. In various examples, the phase shift mask can be attenuated PSM or alternating PSM. The mask(s) generated by the mask fabrication 1344 is used in a variety of processes. For example, such a mask(s) is used in an ion implantation process to form various doped regions in the semiconductor wafer 1353, in an etching process to form various etching regions in the semiconductor wafer 1353, and/or in other suitable processes.

The IC fab 1350 includes wafer fabrication 1352. The IC fab 1350 is an IC fabrication business that includes one or more manufacturing facilities for the fabrication of a variety of different IC products. In some embodiments, the IC Fab 1350 is a semiconductor foundry. For example, there may be a manufacturing facility for the front end fabrication of a plurality of IC products (FEOL fabrication), while a second manufacturing facility may provide the back end fabrication for the interconnection and packaging of the IC products (BEOL fabrication), and a third manufacturing facility may provide other services for the foundry business.

The IC fab 1350 uses mask(s) 1345 fabricated by the mask house 1330 to fabricate the IC 1300. Thus, the IC fab 1350 at least indirectly uses the IC design layout diagram 1322 to fabricate the IC 1300. In some embodiments, the semiconductor wafer 1353 is fabricated by the IC fab 1350 using mask(s) 1345 to form the IC 1300. In some embodiments, the IC fabrication includes performing one or more lithographic exposures based at least indirectly on the IC design layout diagram 1322. The Semiconductor wafer 1353 includes a silicon substrate or other proper substrate having material layers formed thereon. The semiconductor wafer 1353 further includes one or more of various doped regions, dielectric features, multilevel interconnects, and the like (formed at subsequent manufacturing steps).

By using localized increased power grid density for targeted cells, as described above, IR-drop can be reduced for the targeted cells without unnecessary increasing power grid density everywhere in the integrated circuit device. As a result, unnecessary increase in the severity of constraints on placement and routing is avoided for regions away from the targeted cells. As a consequence, the overall utilization (i.e., the fraction of die area occupied by cells (e.g., standard cells) can be higher for localized increased power grid density as compared to the scenario in which the power grid density is increased for the entire integrated circuit device. Increased utilization can also lead to enhanced performance, i.e., higher speed. The PPA for the integrated circuit device can therefore be improved by a targeted power grid design.

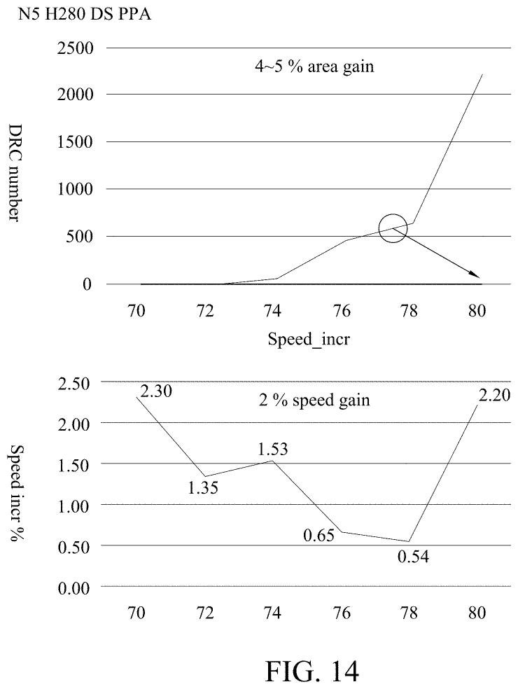

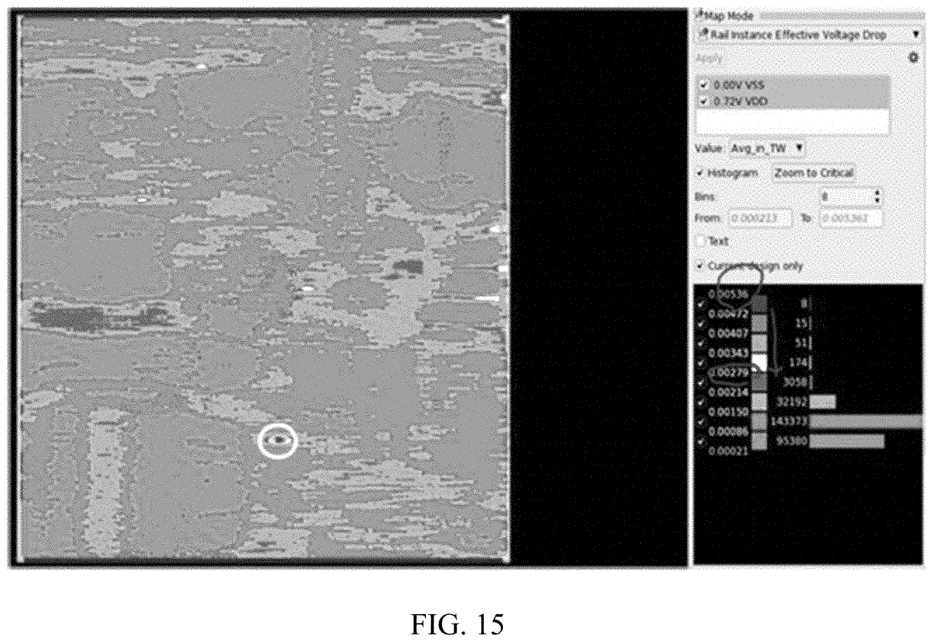

For example, as shown in the upper plot in FIG. 14, the design-rule check (DRC) number (vertical axis), which is a measure of degree of conflict with the design rules for an integrated circuit device, generally increases with utilization (horizontal axis). Utilization is limited by the maximum DRC number that is deemed acceptable (e.g., 500). In this example, without targeted power grid, i.e., with increased power grid density for the entire integrated circuit device due to the need to reduce IR-drop to an acceptable level, utilization is limited to about 77% (indicated by the circle in the graph). With targeted power grid design, power grid density needs not be increased for the entire integrated circuit device; the maximum acceptable DRC number is reached at a higher utilization (as indicated by the arrow in the graph), e.g., about 80%, which represents a 4-5% increase in utilization. As shown in the lower lot in FIG. 14, the percentage speed increase (vertical axis) in this example decreases with utilization (horizontal axis) without targeted power grid design and is only about 0.6 at 77% utilization. With targeted power grid design, the percentage speed increase is about 2%, which represents a significant enhancement in performance.

FIG. 15 shows an example IR-drop map for an integrated circuit device before targeted power grid is included in the design. An IR-drop hotspot (indicated by the circle in the IR-drop map) is identified, and reduced-resistance paths are provided between the power supply lines VSS and the VDD to the cell associated with IR-drop hotspot in the design. As a result IR-drop is locally reduced by about 50%.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit device, comprising:
a first plurality of conductive lines disposed in a first layer;
an active semiconductor layer defining a plurality of functional cells, each directly connected to, and configured to receive power from, at least one of the first plurality of conductive lines;
a second plurality of conductive lines disposed in a second layer;
a third plurality of conductive lines disposed in a third layer intervening the first and second layers, and connected to the first and second plurality of conductive lines,
a first portion of the third plurality of conductive lines being connected to a first one of the plurality of functional cells through the at least one of the first plurality of conductive lines and having a first areal density of conductive lines,
a second portion of the third plurality of conductive lines being connected to a second one of the plurality of functional cells through the at least one of the first plurality of conductive lines and having a second areal density of conductive lines,
the areal density of conductive lines of the first portion being higher than the areal density of conductive lines of the second portion.

2. The integrated circuit device of claim 1, wherein the first portion of the third plurality of conductive lines is isolated from the second portion of the third plurality of conductive lines.

3. The integrated circuit device of claim 1, wherein the first portion of the third plurality of conductive lines is disposed directly above at least a portion of the first one of the plurality of functional cells.

4. The integrated circuit device of claim 1, further comprising:
a fourth plurality of conductive lines disposed in a fourth layer intervening the first and second layers, and connected to the first and second plurality of conductive lines,
a first portion of the fourth plurality of conductive lines being connected to the first one of the plurality of functional cells through the at least one of the first plurality of conductive lines and having a first areal density of conductive lines,
a second portion of the fourth plurality of conductive lines being connected to the second one of the plurality of functional cells through the at least one of the first plurality of conductive lines and having a second areal density of conductive lines,
the areal density of conductive lines of the first portion of the fourth plurality of conductive lines being higher than the areal density of conductive lines of the second portion of the fourth plurality of conductive lines; and
a plurality of conductive pillars interconnecting the third and fourth plurality of conductive lines,
a first portion of the conductive pillars interconnecting the first portion of the third plurality of conductive lines and the first portion of the fourth plurality of conductive lines,
a second portion of the conductive pillars interconnecting the second portion of the third plurality of conductive lines and the second portion of the fourth plurality of conductive lines.

5. The integrated circuit device of claim 4, wherein at least one of the first portion of the third plurality of conductive lines and the first portion of the fourth plurality of conductive lines includes two or more conductive lines connected to each conductive line in the other one of the first portion of the third plurality of conductive lines and the first portion of the fourth plurality of conductive lines by one or more of the first portion of the conductive pillars.

6. The integrated circuit device of claim 5, wherein each of the first portion of the third plurality of conductive lines and the first portion of the fourth plurality of conductive lines includes two or more conductive lines connected to each of the conductive lines in the other one of the first portion of the third plurality of conductive lines and the first portion of the fourth plurality of conductive lines by the first portion of the conductive pillars.

7. The integrated circuit device of claim 4, wherein each conductive line in the first portion of the third plurality of conductive lines extends in a first direction, and each conductive line in the first portion of the fourth plurality of conductive lines extending a second direction substantially transverse to the first direction.

8. The integrated circuit device of claim 3, wherein at least one of the second plurality of conductive lines is disposed at a distance away from the first functional cell in a direction parallel to the first layer, the integrated circuit device further comprising a fourth plurality of conductive lines disposed in a fourth layer intervening the second and third layers, at least one of the forth plurality of conductive lines is connected to the first portion of the third plurality of conductive lines and connected to the at least one of the second plurality of conductive lines.

9. The integrated circuit device of claim 8, where in the at least one of the fourth plurality of conductive lines is connected to the at least one of the second plurality of conductive lines through a plurality of conductive lines disposed in at least one layer intervening the fourth and second layers.

10. The integrated circuit device of claim 1, wherein the first one of the plurality of functional cells is configured to operate at a higher current level than the second one of the plurality of functional cells.

11. An integrated circuit device, comprising:
a first plurality of conductive lines disposed in a first layer;
an active semiconductor layer defining a plurality of functional cells, each connected to, and configured to receive power from, at least one of the first plurality of conductive lines;
a second plurality of conductive lines disposed in a second layer;
a first conductive path disposed between the first and second layers and interconnecting at least one of the second plurality of conductive lines and a conductive line that is one of the at least one of first plurality of conductive lines and is connected to a first one of the plurality of functional cells; and
a second conductive path disposed between the first and second layers and interconnecting at least one of the second plurality of conductive lines and a conductive line that is one of the at least one of first plurality of conductive lines and is connected to a second one of the plurality of functional cells,
wherein the first conductive path has a lower resistance than the second conductive path.

12. The integrated circuit device of claim 11, wherein:
the first conductive path comprises a first plurality of layers of one or more conductive lines, at least one of the first plurality of layers including a plurality of conductive lines,
the second conductive path comprises a second plurality of layers of one or more conductive lines,
each of the first plurality of players is coplanar with a corresponding one of the second plurality of bears.

13. The integrated circuit device of claim 12, wherein the conductive lines of at least a subset of the first plurality of layers are disposed directly above at least a portion of the first one of the plurality of functional cells.

14. The integrated circuit device of claim 12, wherein the one or more conductive lines in each of the first plurality of layers extend in a direction substantially transverse to a direction in which the one or more conductive lines in a neighboring one of the first plurality of players extend.

15. The integrated circuit device of claim 13, wherein at least one of the second plurality of conductive lines is disposed at a distance away from the first one of the plurality of functional cells in a direction parallel to the first layer, at least one of the one or more conductive lines in one of the first plurality of layers is connected to the conductive line that is one of the at least one of first plurality of conductive lines and is connected to a first one of the plurality of functional cells and connected to the at least one of the second plurality of conductive lines.

16. The integrated circuit device of claim 11, wherein the first conductive path and the second conductive path are isolated from each other except at the first and second layers.

17. The integrated circuit device of claim 12, wherein the one or more conductive lines in each of the first plurality of players are isolated from the one or more conductive lines in the respective coplanar one of the second plurality of layers.

18. A method of making an integrated circuit device, the method comprising:
forming a plurality of functional cells in an active semiconductor layer, wherein a first one of the plurality of functional cells is expected to draw a larger current than a second one of the plurality of functional cells under a predetermined operating condition; and
forming a power grid configured to transfer power from a power supply to each of the plurality of functional cells, the power grid including a plurality of conductive layers above the active semiconductor layer, each conductive layer including a plurality of conductive line segments, the power grid further including a plurality of conductive pillars between each adjacent pair of the plurality of conductive layers and between the active semiconductor layer and one of the plurality of conductive layers,
wherein a first subset of the plurality of conductive line segments and a first subset of the plurality of conductive pillars forming a first conductive path to the first one of the plurality of functional cells, a second subset of the plurality of conductive line segments and a second subset of the plurality of conductive pillars forming a second conductive path to the second one of the plurality of functional cells, the first conductive path having a lower resistance than the second conductive path.

19. The method of claim 18, wherein the first conductive path and the second conductive path do not share any of the conductive line segments in at least one of the plurality of conductive layers.

20. The method of claim 18, wherein the first conductive path is a dedicated conductive path between the power supply and the first one of the plurality of functional cells.
